(19) United States
(12) Patent Application Publication
(10) Pub. No.: US 2018/0053593 A1
(43) Pub. Date: Feb. 22, 2018

(54) TRANSFORMER EMBEDDED WITH THERMALLY CONDUCTIVE MEMBER

(71) Applicant: CHROMA ATE INC., Tao-Yuan City (TW)

(72) Inventors: Hsiu-Wei KUO, Tao-Yuan City (TW); Kuei-Wen LIEN, Tao-Yuan City (TW)

(21) Appl. No.: 15/611,773

(22) Filed: Jun. 1, 2017

(30) Foreign Application Priority Data
Aug. 22, 2016 (TW) 105126797

(51) Int. Cl. H01F 27/20; H01F 27/24; H01F 27/28; H01F 27/32

(52) U.S. Cl. CPC H01F 27/20; H01F 27/24; H01F 27/324; H01F 27/323; H01F 27/2823

(57) ABSTRACT

A transformer includes an iron core, at least one winding, and at least one first thermally conductive member. The winding is wound onto the iron core. The winding has a plurality of wiring layers. The thermally conductive member is thermally connected between adjacent two of the wiring layers. The thermally conductive member is configured to circulate a heat transfer fluid therein.

### RELATED APPLICATIONS

This application claims priority to Taiwan Application Serial Number 105126797, filed Aug. 22, 2016, which is herein incorporated by reference.

### BACKGROUND

### Technical Field

The present disclosure relates to a transformer.

### Description of Related Art

Transformers are commonly used for energy transfer and conversion. During operation, a transformer will heat up due to many factors. For example, the current flowing through the winding of the transformer will cause the resistive heating of the conductor of the transformer, and the heat is dissipated by the conductor. Specifically, the induced eddy currents will circulate within the iron core of the transformer, thereby causing the resistive heating. The heat in the iron core produced by that the eddy currents will then be transferred to other components of the transformer. In addition, the residual DC current in the transformer will also cause the transformer to heat up. Therefore, the operation of the transformer is often accompanied with the heating of the transformer.

A conventional approach of cooling a transformer is forcibly cooling by air (e.g., by using a fan). However, the approach is not effective to efficiently dissipate the heat produced during the operation of the transformer. Therefore, the difference between the temperature of the transformer in operation and the room temperature is still too large, which seriously affects the performance of the transformer.

Accordingly, how to provide a transformer to solve the aforementioned problems becomes an important issue to be solved by those in the industry.

### SUMMARY

An aspect of the disclosure is to provide a transformer embedded with one or more thermally conductive members to effectively reduce the temperature in operation.

According to an embodiment of the disclosure, a transformer includes an iron core, at least one winding, and at least one first thermally conductive member. The winding is wound onto the iron core. The winding has a plurality of wiring layers. The thermally conductive member is thermally connected between adjacent two of the wiring layers. The thermally conductive member is configured to circulate a heat transfer fluid therein.

Accordingly, in the transformer of the disclosure, the first thermally conductive member is disposed between the adjacent two wiring layers of the winding, so the heat produced by the winding during the operation of the transformer can be effectively dissipated. Therefore, the difference between the temperature of the transformer of the disclosure in operation and the room temperature can be significantly reduced, so as to improve the performance of the transformer of the disclosure.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a transformer according to an embodiment of the disclosure;

FIG. 2 is a partial top view of the transformer in FIG. 1;

FIG. 3 is an abridged general view of some components of the transformer in FIG. 1;

FIG. 4 is a cross-sectional view of the first thermally conductive member taken along line 4-4 in FIG. 3; and

FIG. 5 is an abridged general view of some components of a transformer according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

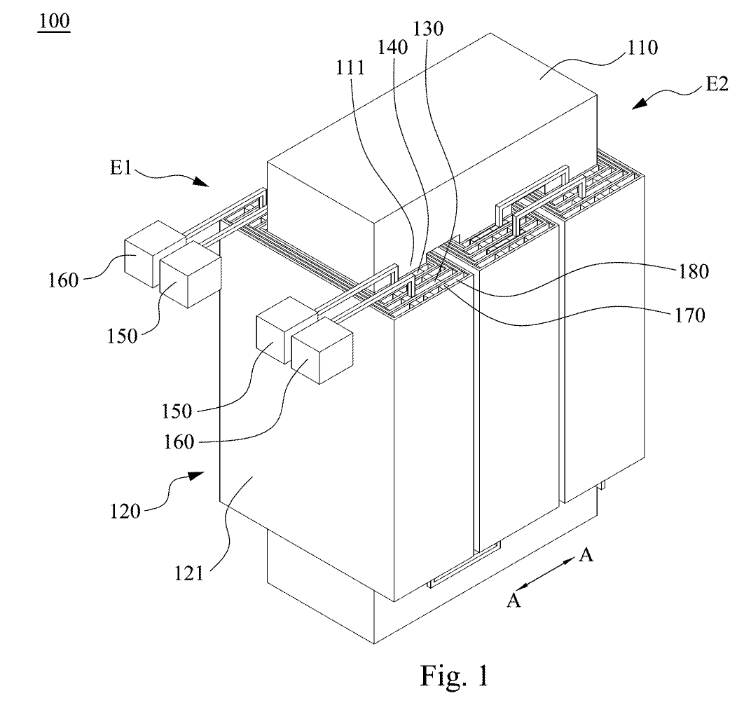

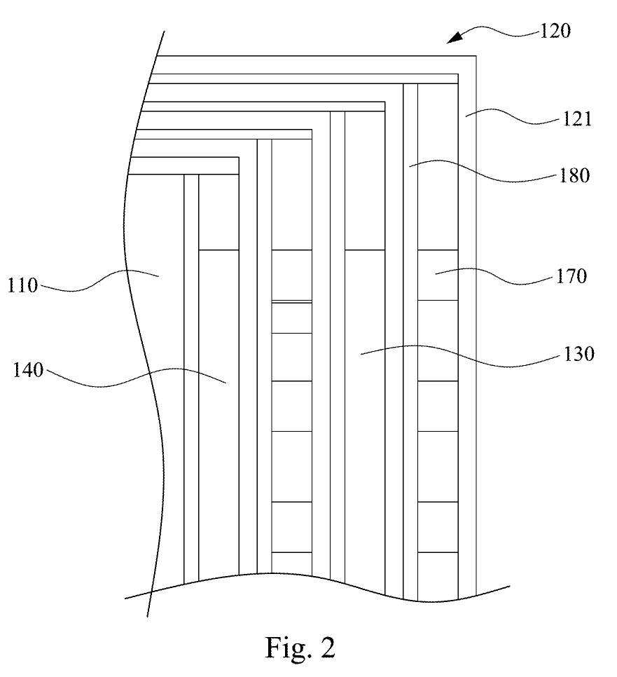

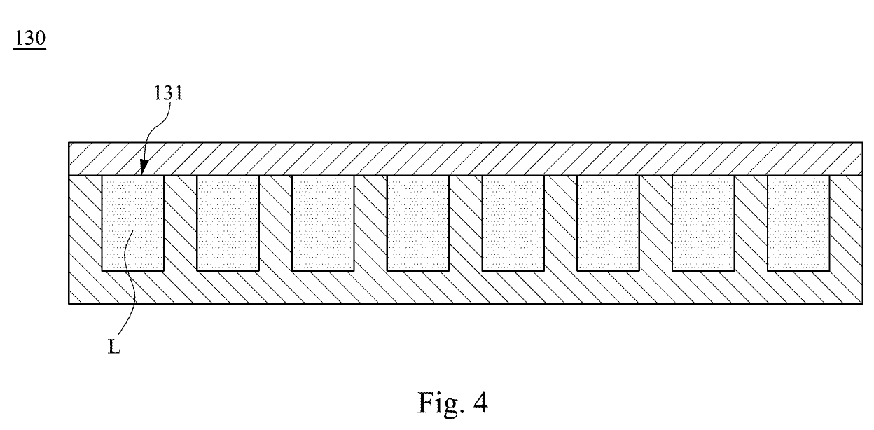

Reference is made to FIGS. 1 and 2. FIG. 1 is a perspective view of a transformer 100 according to an embodiment of the disclosure. FIG. 2 is a partial top view of the transformer 100 in FIG. 1. As shown in FIGS. 1 and 2, in the embodiment, the transformer 100 includes an iron core 110, a plurality of windings 120, a plurality of first thermally conductive members 130, a plurality of second thermally conductive members 140, and a fluid output module 150. The iron core 110 includes a plurality of core portions 111. The windings 120 are respectively wound onto the core portions 111. The first thermally conductive members 130 are respectively corresponded to the core portions 111, and the second thermally conductive members 140 are also respectively corresponded to the core portions 111. Each of the windings 120 has a plurality of wiring layers 121. Each of the first thermally conductive members 130 is thermally connected between adjacent two of the wiring layers 121 of the corresponding winding 120. Hence, the wiring layers 121 thermally connected to the first thermally conductive member 130 can transfer the produced heat to the first thermally conductive member 130. Each of the second thermally conductive members 140 is thermally connected between the corresponding core portion 111 and the corresponding winding 120. Hence, the core portion 111 and the winding 120 thermally connected to the second thermally conductive members 140 can transfer the produced heat to the second thermally conductive members 140. The first thermally conductive members 130 and the second thermally conductive members 140 are in fluid communication with each other and configured to circulate a heat transfer fluid L (see to FIG. 4) therein. The fluid output module 150 is configured to provide the heat transfer fluid L to the second thermally conductive members 140, so the heat transfer fluid L flows to the first thermally conductive members 130 through the second thermally conductive members 140.

With the foregoing structural configurations, the heat that the second thermally conductive members 140 absorb from the thermally connected core portions 111 and the windings 120 can be transferred away by the heat transfer fluid L flowing in the second thermally conductive members 140, and the heat that the first thermally conductive members 130 absorb from the thermally connected wiring layers 121 can be transferred away by the heat transfer fluid L flowing in the first thermally conductive members 130, so as to significantly reduce the temperature of the whole transformer 100.

In the embodiment, the transformer 100 further includes a fluid recycling module 160. The fluid recycling module 160 is in fluid communication with the first thermally conductive members 130 and configured to recycle the heat transfer fluid L flowing in the first thermally conductive members 130. In some embodiments, the fluid output module 150 and the fluid recycling module 160 can be further included in a fluid circulation device (not shown). The fluid circulation device is configured to cool (e.g., by using the cooling mechanism provided by a cooling module including components such as a compressor, a condenser, refrigerant, and etc.) the high temperature heat transfer fluid L recycled by the fluid recycling module 160 and circulate the cooled heat transfer fluid L to the second thermally conductive members 140 through the fluid output module 150.

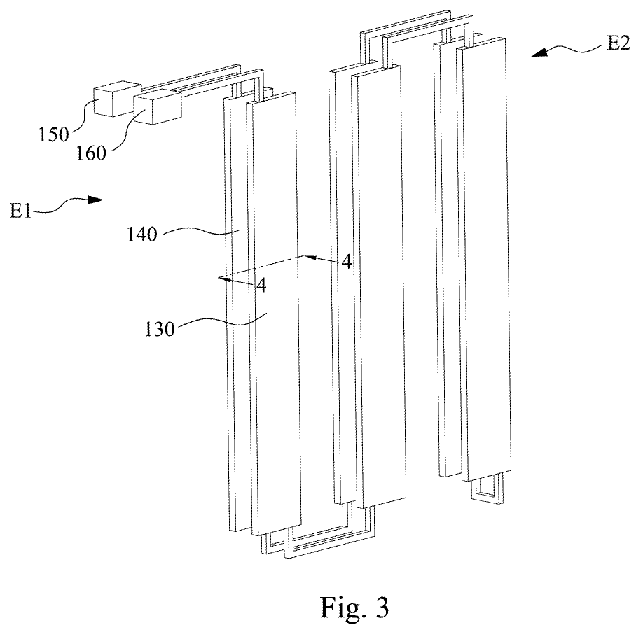

Reference is made to FIG. 3. FIG. 3 is an abridged general view of some components of the transformer 100 in FIG. 1. FIG. 3 illustrates a fluid path constituted by the first thermally conductive members 130 and the second thermally conductive members 140 disposed at one side of the iron core 110. In the embodiment, the second thermally conductive members 140 are sequentially in fluid communication from a first end E1 (i.e., the end proximal to the fluid output module 150) to a second end (i.e., the end distal to the fluid output module 150) of an arrangement direction A along which the core portions 111 are arranged. The first thermally conductive members 130 are sequentially in fluid communication from the first end E1 to the second end E2. The first thermally conductive member 130 and the second thermally conductive member 140 that are arranged close to the second end E2 the most are directly in fluid communication. The fluid output module 150 is configured to provide the heat transfer fluid L to the second thermally conductive member 140 that is arranged close to the second end E2 the most. The fluid recycling module 160 is configured to recycle the heat transfer fluid L from the first thermally conductive member 130 that is arranged close to the first end E1 the most. In other words, the heat transfer fluid L provided by the fluid output module 150 sequentially flows from the second thermally conductive member 140 arranged close to the first end E1 the most to the second thermally conductive member 140 arranged close to the second end E2 the most, then sequentially flows from the first thermally conductive member 130 arranged close to the second end E2 the most to the first thermally conductive member 130 arranged close to the first end E1 the most, and finally is recycled by the fluid recycling module 160.

In the embodiment, a fluid inlet and a fluid outlet of each of the first thermally conductive members 130 and the second thermally conductive members 140 are respectively located at the upper side and the lower side, but the disclosure is not limited in this regard. In the embodiment, the fluid inlet and the fluid outlet of at least one of the first thermally conductive members 130 and the second thermally conductive members 140 are located at the same side (i.e., the upper side or the lower side).

In practical applications, with reference to FIG. 1, the fluid paths constituted by the first thermally conductive members 130 and the second thermally conductive members 140 disposed at two sides of the iron core 110 can be selectively designed to be symmetric or asymmetric. That is, the fluid paths at two sides of the iron core 110 can be flexibly adjusted as needed. For example, the heat transfer fluids L in both of the fluid paths flowing from the first end E1 may cause the temperatures of the core portion 111 and the winding 120 arranged at the second end E2 to be greater than the temperatures of the core portion 111 and the winding 120 arranged at the first end E1, which may result in the uneven heat dissipation of the transformer 100 and affect the overall performance. In order to eliminate the temperature difference between the first end E1 and the second end E2, the heat transfer fluid L in the fluid path located at one side of the iron core 110 can flow from the first end E1, and the heat transfer fluid L in the fluid path located at another side of the iron core 110 can flow from the second end E2.

In some embodiments, the first thermally conductive members 130 and the second thermally conductive members 140 are structurally the same. Reference is made to FIG. 4. FIG. 4 is a cross-sectional view of the first thermally conductive member 130 taken along line 4-4 in FIG. 3. As shown in FIG. 4 taking the first thermally conductive member 130 as an illustration, the first thermally conductive member 130 is a metal board having a flow channel 131 therein, and the heat transfer fluid L flows in the flow channel 131. In some embodiments, the first thermally conductive member 130 can be assembled by two plates, but the disclosure is not limited in this regard. In some embodiments, the flow channel 131 is formed in the interior of the first thermally conductive member 130 in a repetitive circuitous form similar to the S-shape, but the disclosure is not limited in this regard.

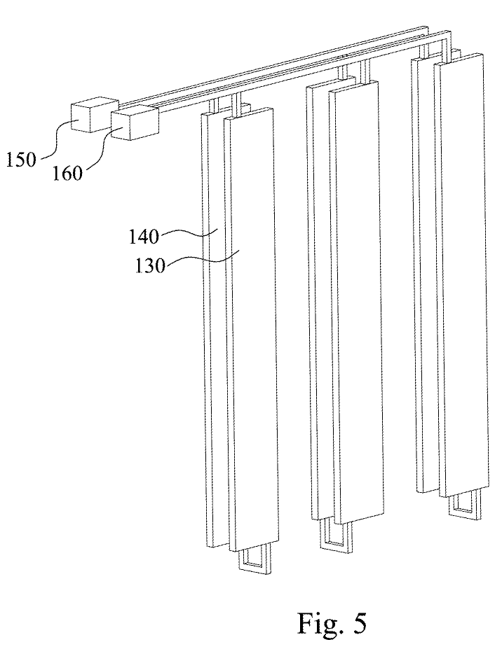

Reference is made to FIG. 5. FIG. 5 is an abridged general view of some components of a transformer 100 according to another embodiment of the disclosure. FIG. 5 illustrates a fluid path constituted by the first thermally conductive members 130 and the second thermally conductive members 140 disposed at one side of the iron core 110. In the embodiment, the second thermally conductive members 140 are individually in fluid communication with the fluid output module 150. The first thermally conductive members 130 are individually in fluid communication with the fluid recycling module 160. The second thermally conductive members 140 are respectively in fluid communication with the first thermally conductive members 130. In other words, the fluid output module 150 provides the heat transfer fluid L to the second thermally conductive members 140 at the same time, the heat transfer fluid L flowing in each of the second thermally conductive members 140 then flows to the corresponding one of the first thermally conductive members 130, and the fluid recycling module 160 recycles the heat transfer fluid L from the first thermally conductive members 130 at the same time. With the fluid path of the present embodiment, the temperatures of the core portion 111 and the winding 120 arranged at the second end E2 can be more consistent with the temperatures of the core portion 111 and the winding 120 arranged at the first end E1, and the heat produced by the transformer 100 can be uniformly dissipated.

In some embodiments, the transformer 100 can be designed to provide the heat transfer fluid L to the first thermally conductive members 130 by the fluid output module 150 and recycle the heat transfer fluid L from the second thermally conductive members 140 by the fluid recycling module 160. For example, if the iron core 110 produces more heat than the windings 120 (or the iron core 110 has a higher temperature), the heat transfer fluid L can be provided to the second thermally conductive members 140 by the fluid output module 150, so as to rapidly take the heat produced by the iron core 110 away by the heat transfer fluid L having a lower temperature and avoid a lot of heat accumulated in the iron core 110. Relatively, if the windings 120 produce more heat than the iron core 110 (or the windings 120 have higher temperatures), the heat transfer fluid L can be provided to the first thermally conductive members 130 by the fluid output module 150, so as to rapidly take the heat produced by the windings 120 away by the heat transfer fluid L having a lower temperature and avoid a lot of heat accumulated in the windings 120.

As shown in FIGS. 1 and 2, in the embodiment, the transformer 100 further includes a plurality of ventilation strips 170. Each of the ventilation strips 170 is disposed between adjacent two of the wiring layers 121 and configured to maintain a gap between the adjacent two of the wiring layers 121. Hence, it is helpful for the external airflow to pass through the gap to take the heat produced by the wiring layers 121 away.

In the embodiment, any adjacent two of the wiring layers 121 between which no first thermally conductive member 130 is disposed are disposed with the ventilation strips 170. That is, for any adjacent two of the wiring layers 121 between which at least one first thermally conductive member 130 is disposed, the heat produced by the wiring layers 121 can be taken away by the first thermally conductive member 130 in a heat conduction manner; and for any adjacent two of the wiring layers 121 between which no first thermally conductive member 130 is disposed, the heat produced by the wiring layers 121 can be taken away via the gap formed by the ventilation strips 170 in a heat convection manner.

As shown in FIGS. 1 and 2, in the embodiment, the transformer 100 further includes a plurality of insulating layers 180 respectively disposed between the wiring layers 121 and between the iron core 110 and each of the windings 120, and configured to insulate the wiring layers 121 from each other and insulate the iron core 110 from each of the windings 120. In some embodiments, the insulating layers 180 are insulating papers, but the disclosure is not limited in this regard.

In some embodiments, the transformer 100 can only include the first thermally conductive members 130 without the second thermally conductive members 140, the fluid output module 150 directly provides the heat transfer fluid L to the first thermally conductive members 130, and the fluid recycling module 160 directly recycle the heat transfer fluid L from the first thermally conductive members 130. In some other embodiments, the transformer 100 can only include the second thermally conductive members 140 without the first thermally conductive members 130, the fluid output module 150 directly provides the heat transfer fluid L to the second thermally conductive members 140, and the fluid recycling module 160 directly recycle the heat transfer fluid L from the second thermally conductive members 140.

As shown in FIG. 1, in the embodiment, the number of the core portions 111 included by the iron core 110 and the numbers of the first thermally conductive members 130 and the second thermally conductive members 140 at one side of the iron core 110 are three, but the disclosure is not limited in this regard and can be flexibly adjusted as needed. In practical applications, the type of the iron core 110 adopted in the transformer 100 is not limited by the iron core 110 shown in FIG. 1.

As shown in FIG. 1, in the embodiment, the number of the wiring layers 121 included in each of the windings 120 is four, but the disclosure is not limited in this regard and can be flexibly adjusted as needed.

In some embodiments, the material of the wiring layers 121 includes copper, but the disclosure is not limited in this regard.

According to the foregoing recitations of the embodiments of the disclosure, it can be seen that in the transformer of the disclosure, the first thermally conductive member is disposed between the adjacent two wiring layers of the winding, so the heat produced by the winding during the operation of the transformer can be effectively dissipated. Therefore, the difference between the temperature of the transformer in operation and the room temperature can be significantly reduced, so as to improve the performance of the transformer of the disclosure. In order to decrease the temperature of the transformer more efficiently, the transformer of the disclosure further includes the second thermally conductive member disposed between the iron core and the winding, so as to so the heat produced by the iron core during the operation of the transformer can be effectively dissipated. In addition, the transformer of the disclosure can selectively provide the heat transfer fluid from the first thermally conductive member or the second thermally conductive member according to the amounts of heat (or temperatures) of the iron core and the winding.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A transformer, comprising:
an iron core;
at least one winding wound onto the iron core, the winding having a plurality of wiring layers; and
at least one first thermally conductive member thermally connected between adjacent two of the wiring layers, the first thermally conductive member being configured to circulate a heat transfer fluid therein.

2. The transformer of claim 1, further comprising:
at least one second thermally conductive member thermally connected between the iron core and the winding, the second thermally conductive member being in fluid communication with the first thermally conductive member and configured to circulate the heat transfer fluid therein.

3. The transformer of claim 2, further comprising:
a fluid output module configured to provide the heat transfer fluid to the second thermally conductive member.

4. The transformer of claim 2, wherein each of the first thermally conductive member and the second thermally conductive member is a metal board having a flow channel therein.

5. The transformer of claim 1, further comprising a plurality of the windings and a plurality of the first thermally conductive members, wherein the iron core comprises a plurality of core portions, the windings are respectively wound onto the core portions, and the first thermally conductive members are in fluid communication with each other and located at a side of the iron core.

6. The transformer of claim 5, further comprising:
a plurality of second thermally conductive members each thermally connected between a corresponding one of the core portions and a corresponding one of the windings and located at the side of the iron core, the second thermally conductive members being configured to circulate the heat transfer fluid therein and in fluid communication with the first thermally conductive members.

7. The transformer of claim 6, wherein the second thermally conductive members are sequentially in fluid communication from a first end to a second end of an arrangement direction along which the core portions are arranged, the first thermally conductive members are sequentially in fluid communication from the first end to the second end, and the first thermally conductive member and the second thermally conductive member that are arranged dose to the second end the most are directly in fluid communication.

8. The transformer of claim 7, further comprising:
a fluid output module configured to provide the heat transfer fluid to the second thermally conductive member that is arranged dose to the second end the most.

9. The transformer of claim 1, further comprising:
a plurality of ventilation strips each disposed between adjacent two of the wiring layers and configured to maintain a gap between the adjacent two of the wiring layers.

10. The transformer of claim 1, further comprising:
a plurality of insulating layers respectively disposed between the wiring layers and between the iron core and the winding, and configured to insulate the wiring layers from each other and insulate the iron core from the winding.
